(19) United States
(12) Patent Application Publication
(10) Pub. No.: US 2019/0051053 A1
(43) Pub. Date: Feb. 14, 2019

(54) METHOD AND SYSTEM FOR SUPERIMPOSING A VIDEO IMAGE ON AN OBJECT IMAGE

(71) Applicant: Ryan SIT, Rancho Santa Fe, CA (US)

(72) Inventor: Ryan SIT, Rancho Santa Fe, CA (US)

(21) Appl. No.: 15/676,940

(22) Filed: Aug. 14, 2017

(51) Int. Cl. G06T 19/00; G06T 7/73

(52) U.S. Cl. CPC G06T 19/006; G06T 7/73; G06T 2207/30201; G06T 2207/10016; G06T 2207/20021; G06T 2207/30204

(57) ABSTRACT

Disclosed herein are methods of superimposing a video image of a body part of a user over an image of an object, the method comprising the steps of: obtaining a streaming video image of a user, wherein the streaming video image comprises video image of a body part of a user; detecting two or more landmarks on the user's body part; calculating a position and/or size of the video image of the user's body part in the video image with respect to the image of the object; placing the video image of the user's body part in a container in a proper position with respect to the image of the object; wherein the video image of the user's body part is a continuous live stream of the video image throughout the superimposing process.

### FIELD OF THE INVENTION

The present invention is in the field of electronic manipulation of a video stream and superimposing said stream on an image of an object.

### BACKGROUND OF THE DISCLOSURE

Those wishing to purchase an article of clothing must imagine how that object would look like in the environment in which the object is used. For example, shoppers may find a desirable article of clothing, but, unless they physically go to the store and try on the clothes, they could not know for certain how that article of clothing would look on them when it is worn. Online shoppers cannot go directly to the store. Therefore, they routinely purchase items that, while they look good online, when received and tried on, the clothes clash with the person's skin color, body proportions, or the like. Similarly, if a person wishes to purchase a friend an article of clothing as a gift, the person must try to imagine the friend wearing the clothes and guess whether the clothes on the friend would look fashionable.

Certain methods are known in the art for superimposing a photograph of the shopper, or the shopper's relevant body part, on an image of the article of clothing to better assist the shopper in choosing the proper clothes. However, these methods are inadequate because they superimpose a still image of the shopper on a still image of the article of clothing. The shopper's still image may be in a different orientation than that of the article of clothing. Similarly, these methods do not provide a proper melding of the shopper's body lines with that of the clothes.

### SUMMARY OF THE INVENTION

Disclosed herein are methods of superimposing a video image of a body part of a user over an image of an object, the method comprising the steps of: obtaining a streaming video image of a user, wherein the streaming video image comprises video image of a body part of a user; detecting two or more landmarks on the user's body part; calculating a position and/or size of the video image of the user's body part in the video image with respect to the image of the object; placing the video image of the user's body part in a container in a proper position with respect to the image of the object; wherein the video image of the user's body part is a continuous live stream of the video image throughout the superimposing process.

### DETAILED DESCRIPTION OF THE EMBODIMENTS

Disclosed herein are methods and systems for obtaining a video stream of the shopper and imposing the video image on an image of an article of clothing. Since the image of the shopper is a video stream, the shopper is able to move their body in the proper orientation so that the combined image of the shopper and the article of clothing resembles an image of the shopper wearing the clothes.

During in-person shopping at a store, shoppers usually grab a garment off the rack and hold it in front of their body and move their head to see how the garment would look on them. A further advantage of the methods and systems disclosed herein is that their use closely resembles, and the experience compares well with, the actual in-person shopping experience. By placing the streaming video image of the user's head in a container (see below) and having the container above the image of the garment, the shopper sees an image that closely resembles what the shopper would see in a mirror in a store while holding the garment in front of them. This feature induces a strong positive effect on the shopper's experience.

Thus, in one aspect, disclosed herein are methods of superimposing a video image of a body part of a user over an image of an object, the method comprising the steps of:
obtaining a streaming video image of a user, wherein the streaming video image comprises video image of a body part of a user;
detecting two or more landmarks on the user's body part;
calculating a position and/or size of the video image of the user's body part in the video image with respect to the image of the object;
placing the video image of the user's body part in a container in a proper position with respect to the image of the object;

wherein the video image of the user's body part is a continuous live stream of the video image throughout the superimposing process.

In some embodiments, the body part of the user is the head and face of the user. In other embodiments, the body part of the user is the torso of the user. In some of these embodiments, the torso and the face are both included in the video image. In some embodiments, two or more of the user's facial landmarks are detected in the detecting step.

In other embodiments, the face or the head of the user is not in the streaming video image and only the user's torso or legs are shown in the video image. In these embodiments, two or more landmarks are on the user's torso.

In some embodiments, the container is a circular space. In other embodiments, the container is of a different geometrical shape. For example, in some embodiments, the container is a square, a rectangle, a triangle, a trapezoid, a parallelogram, or another defined or undefined geometrical shape. The ordinary artisan recognizes that some shapes for the container are better matched with the streaming video image of certain body parts. For example, a circular container could be preferred when the streaming video image is that of the user's face and/or head, while a rectangular container could be preferred when the streaming video image is that of the user's torso. Certainly the ordinary artisan recognizes that the use of one shape for the container does not foreclose its use with the streaming video images of any and all of the user's body parts.

In some embodiments, the object is a product for sale. In certain embodiments, the product is an article of clothing. Examples of articles of clothing include, but are not limited to, hats, shirts (T, button down, short sleeve, etc.), pants, skirts, shorts, dresses, suits, ties, scarves, underwear, bathing suits, socks, shoes, and the like.

In some embodiments, the above methods further comprise the step of connecting a portion of the video image of the user's body part with the image of the object such that the user's body part appears to be in approximately the same position as the corresponding body part of the model in the image of the object. Thus, for instance, if the user is attempting to superimpose an image of the user's head in place of the model's head in the image of the object, the software places the container where the image of the model's head appears. Then the user places the streaming video image of the user's head in the container such that the user's neck touches the image of the object's torso at approximately the same spot as the model's head would have been, such that the user's neck and the model's neck superimpose.

By “superimposing” or “placing” an image it is meant that a point or pixel of the user's body part in the streaming video image is placed at the spot where the point or pixel of the corresponding body part of the model would have appeared. By “approximately” throughout the present disclosure it is meant that if a point or pixel of the image of the object appears at the location (x,y), then the corresponding point or pixel of the streaming video image appears at location (x±20%,y±20%), or alternatively location (x±10%,y±10%), or alternatively location (x±5%,y±5%).

In some embodiments, the above methods further comprise uploading the image of the object into a user device prior to the calculating step. In some embodiments, the user device is selected from a computer (desktop or laptop), a mobile phone, a smart tablet (e.g., Apple® iPad®, Microsoft® Surface®, Google® Pixel®, Samsung® Galaxy®, Amazon® Fire®, RCA® Cambio®, and the like), a smart watch, or any other similarly functioning device known now or developed later. The ordinary artisan, and indeed an ordinary user of a user device, is familiar with the steps required to upload an image into the user device. It must be noted that the exact nature of the user device is not critical to the carrying out of the steps of the presently disclosed methods. Any device that can receive and manipulate a digitized image can be used with the methods described herein.

In some embodiments, the present methods further comprise accounting for the pitch, roll, and/or yaw (PRY) of the body part with respect to the image of the object prior to the placing step. By “accounting for” in the context of this step it is meant that the software used for this process recognizes the PRY of the streaming video image with respect to that of the image of the object and electronically manipulates either the image of the object or the streaming video image, or both, to match the PRY of one with that of the other. When the PRY is “accounted for” the streaming video image and the image of the object are in the same spatial orientation. For instance, if the user's head is tilted forward or backward (yaw) at a different angle than that of the head of the model in the image of the object, then the software electronically changes the tilt, or the yaw, of the user's head in the streaming video image to match that of the model in the image of the object. In some embodiments, the user makes the coarse PRY correction by moving the camera in a proper direction to place the image of the user's body part in approximately the same orientation as the body part of the model in the image of the object. The software then makes the fine PRY correction to match the images as best as possible.

In some embodiments, the image of the object is obtained from a database of object images, wherein the database is publicly managed; privately managed and non-user controlled; or user controlled. A “publicly managed database” is a database of images that is available online to the members of the public. These databases include an online catalog, the website of a store showing products available for sale, websites of news or entertainment outlets, and the like. A “privately managed and non-user controlled database” is a database that is available to a select group of users, but the user of the herein described methods does not have any upload control over the database. That is, the user can download images from the database, but cannot upload images to the database. Examples of these databases include, but are not limited to, an exclusive database of images, where paid membership to the website or its image database is required for access to the database, or a collection of photographs stored on a third party (e.g., a friend) device. A “user controlled database” is one which is owned and controlled by the user. An example includes the collection of images and photographs on the user device.

In some embodiments, the image of the object is an image of an article of clothing worn by a model. In certain embodiments, the image is a printed image, for example found in a catalog, magazine, newspaper, advertisement, and the like. In these embodiments, the user obtains a photograph of the image with a camera, such as a free standing camera, a mobile phone camera, a smart tablet camera, and the like. In some of these embodiments, the image is easily digitized, either by obtaining the image electronically, or by scanning a printed image or otherwise digitizing the image. In other embodiments, the model is a mannequin at a store wearing the desired article of clothing. In other embodiments, the model is a friend of the user. In some embodiments, the model is a clothes hanger on which the article of clothing is hung.

In some embodiments, the placing step is carried out automatedly. An automated placement comprises a determination by the software as to where the image should be placed. Automated placement includes a coarse placement by the user, with the fine placement taking place automatedly. Thus, in some embodiments, the user manually adjusts the position of the video image of the user's body part in the placing step.

In some embodiments, the method steps are carried out on a server, on a user device, or a combination thereof.

It must be noted that, in addition to the features described above, the presently described methods differ from some of the currently available face-swapping applications, such as SnapChat® and the like. In these applications, only the face of the user is placed in lieu of the face in the image. The “swap” does not include replacing the entire head and the empty space, or air, around the head. Thus, the user sees an image of only their face superimposed on the face of the image, with the hair and the head shape remaining those of the image's.

In most currently available swapping applications, only a specialized photograph of the garment, prepared for the exclusive use of the swap application, can be used. Therefore, the user is limited to try garments whose photographs are available on the application's server. This limitation severely restricts the utility of the currently available applications. By contrast, in the presently described methods, the user may choose any image of the object that the user desires. The image may be one taken from a catalog, an online source, by the user's own camera/phone, or borrowed from the phone/photo collection of a friend.

In another aspect, disclosed herein is a system for superimposing a streaming video image of a user on an image of the object. In some embodiments, the system comprises:
an image database comprising an image of the object;
a camera configured to obtain a streaming video image of the user;
a server having a software configured to automatedly place a streaming video image of a body part of the user over the image of the object.

1. A method of superimposing a video image of a body part of a user over an image of an object, the method comprising the steps of:
obtaining a streaming video image of a user, wherein the streaming video image comprises video image of a body part of a user;
detecting two or more landmarks on the user's body part;
calculating a position and/or size of the video image of the user's body part in the video image with respect to the image of the object;
placing the video image of the user's body part in a container in a proper position with respect to the image of the object;
wherein the video image of the user's body part is a continuous live stream of the video image throughout the superimposing process.

2. The method of claim 1, wherein the body part of a user is the head and face of the user.

3. The method of claim 1, wherein two or more facial landmarks are detected in the detecting step.

4. The method of claim 1, wherein the container is a circular space.

5. The method of claim 1, wherein the object is a product for sale.

6. The method of claim 1, wherein the product is an article of clothing.

7. The method of claim 1, wherein the image of the object is an image of an article of clothing worn by a model.

8. The method of claim 7, further comprising the step of connecting a portion of the video image of the user's body part with the image of the object such that the user's body part appears to be in approximately the same position as the corresponding body part of the model in the image of the object.

9. The method of claim 1, further comprising uploading the image of the object into a user device prior to the calculating step.

10. The method of claim 9, wherein the user device is selected from a camera, a smart phone, a smart tablet, a smart watch, or a laptop or desktop computer,

11. The method of claim 1, further comprising accounting for the pitch, roll, and/or yaw of the body part with respect to the image of the object prior to the placing step.

12. The method of claim 1, wherein the image of the object is obtained from a database of object images, wherein the database is publicly managed; privately managed and non-user controlled; or user controlled.

13. The method of claim 1, wherein the placing step is carried out automatedly.

14. The method of claim 1, wherein the user manually adjusts the position of the video image of the user's body part in the placing step.

15. The method of claim 1, wherein the method steps are carried out on a server, on a user device, or a combination thereof.
